(19) United States
(12) Patent Application Publication
(10) Pub. No.: US 2015/0066955 A1
(43) Pub. Date: Mar. 5, 2015

(54) SYSTEM AND METHOD FOR PROVIDING A METADATA MANAGEMENT FRAMEWORK

(71) Applicant: Verizon Patent and Licensing Inc., Basking Ridge, NJ (US)

(72) Inventors: Jean F. Dubois, Boothbay Harbor, ME (US); Patrick J. Moran, Shrewsbury, MA (US)

(73) Assignee: Verizon Patent and Licensing Inc., Basking Ridge, NJ (US)

(21) Appl. No.: 14/012,479

(22) Filed: Aug. 28, 2013

(51) Int. Cl. G06F 17/30

(52) U.S. Cl. CPC G06F 17/30943
USPC 707/749; 707/736; 707/756; 707/752

(57) ABSTRACT

An approach for adapting a metadata framework in accordance with metadata manipulations is provided. The approach includes determining a first metadata associated with a first content item representing sensor information and a second metadata associated with a second content item representing sensor information. The approach also includes determining a third metadata based on the first metadata and the second metadata and associated the third metadata with a third content item.

### BACKGROUND INFORMATION

Service providers are continually challenged to deliver value and convenience to consumers by, for example, providing compelling network services. One area of development has been the use of metadata to identify and retrieve content items. Data is often received and stored with metadata. The metadata may provide information on interpretation and retrieval of the data. For example, a content item may include metadata that forms a descriptive abstraction or characterization of the content item. A query may relate to the abstraction created by metadata, wherein a system may then output a content item associated with the metadata answering the query. As such, insightful content item retrieval is often contingent upon the accuracy and storage structure of metadata. However, content item metadata and associated storage structures are often static. That is, data is continually categorized in accordance with pre-configured storage structures. As such, service providers and users face challenges in maintaining the accuracy and insight in organization of metadata through various iterations of data or as connections between new data and stored data develop.

Based on the foregoing, there is a need for determining an adaptive metadata framework that incorporates framework changes to reflect metadata input and manipulation.

### BRIEF DESCRIPTION OF THE DRAWINGS

Various exemplary embodiments are illustrated by way of example, and not by way of limitation, in the figures of the accompanying drawings in which like reference numerals refer to similar elements and in which:

FIG. 1 is a diagram of a system capable of adapting a metadata framework in accordance with metadata manipulations, according to one embodiment;

FIG. 2A is a diagram of a sensor platform capable of registering various sensor devices and receiving data intelligently, according to one embodiment;

FIG. 2B is a diagram of a framework platform capable of determining a metadata organization framework, according to one embodiment;

FIG. 3A is a diagram of a data formatter capable of converting raw sensor data into a common format, according to one embodiment;

FIG. 3B is a diagram of the recommendation module capable of determining changes to metadata or metadata frameworks, according to one embodiment;

FIG. 4 is a flowchart of a process for creating metadata, according to one embodiment;

FIG. 5 is a flowchart of a process for generating and validating new metadata to ensure quality metadata, according to one embodiment;

FIG. 6 is a flowchart of a process for modifying a framework to accommodate new metadata, according to one embodiment;

FIG. 7 is a flowchart of a process for modifying a framework based on metadata manipulation, according to one embodiment;

FIG. 8A is a diagram of a metadata framework where content items are abstracted into different metadata views, according to one embodiment;

FIG. 8B is a flowchart of a process for abstracting content items into different metadata views and changing models of metadata relating to content item usage, according to one embodiment;

FIG. 9 is a diagram of a metadata view, specifically one including a common data format for content items and metadata, according to one embodiment;

FIG. 10 is a diagram of a computer system that can be used to implement various exemplary embodiments; and

FIG. 11 is a diagram of a chip set that can be used to implement various exemplary embodiments.

### DESCRIPTION OF THE PREFERRED EMBODIMENT

An apparatus, method, and software for adapting a metadata framework in accordance with metadata manipulations, is described. In the following description, for the purposes of explanation, numerous specific details are set forth in order to provide a thorough understanding of the present invention. It is apparent, however, to one skilled in the art that the present invention may be practiced without these specific details or with an equivalent arrangement. In other instances, well-known structures and devices are shown in block diagram form in order to avoid unnecessarily obscuring the preferred embodiments of the invention.

Although the various exemplary embodiments are described with respect to processing cloud computing and services, it is contemplated that these embodiments have applicability to other computing technologies and architectures.

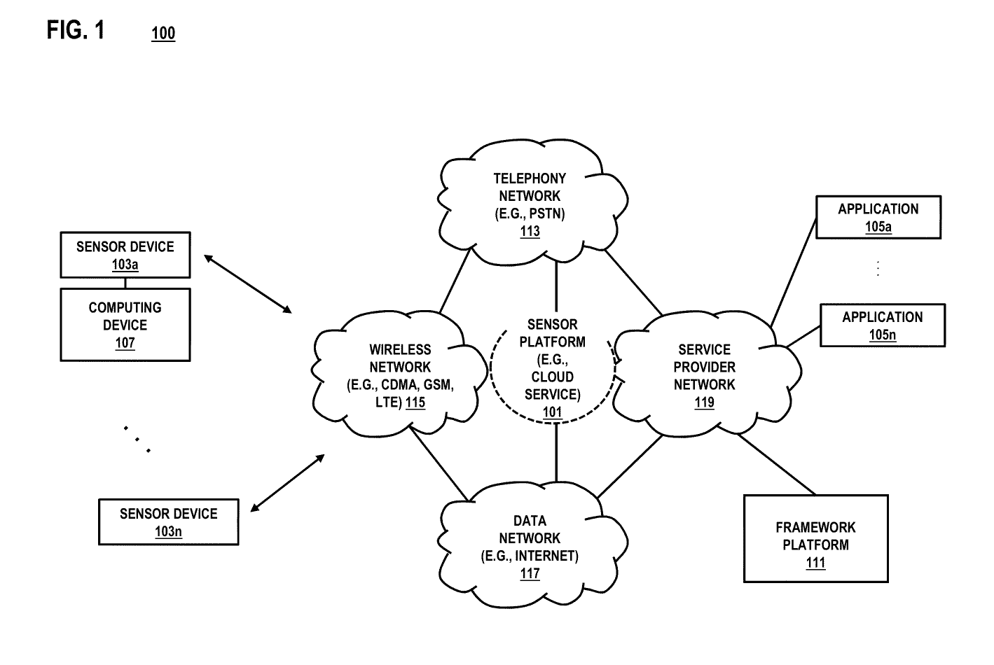

FIG. 1 is a diagram of a system 100 adapting a metadata framework in accordance with metadata manipulations, according to one embodiment. In one embodiment, the system 100 may include a framework platform 111 that provides a flexible metadata framework and distributed data tagging of data collected from one or more sensor devices 103a-103n. For the purpose of illustration, system 100 employs, in certain embodiments, a sensor platform 101 that provides collective analysis for sensor information. To provide a flexible metadata framework, the framework platform 111 determines, in certain embodiments, changes in the underlying metadata frameworks to reflect data and relationships between data. For instance, the system 100, via sensor platform 101, may collect data from various sensors and observe the data for possible correlation between data from different sensors. In one scenario, the sensor platform 101 may employ a data analytics entity to determine possible relationships between data from different sensors. Based on relationships between data, the sensor platform 101 may derive inferences regarding metadata associated with data. Thereafter, the framework platform 111 may build a metadata framework reflective of the relationships between metadata. It is noted that the functionalities of the sensor platform 101 and framework platform 111 may be combined into a single platform or across multiple platforms, depending on the application.

By way of example, the framework platform 111 may be deployed as part of a healthcare-related service, whereby sensor platform 101 may collect data from various healthcare-related sensors. For instance, one data feed may convey the blood pressure of a user, “user A,” while another data feed represents the blood sugar levels of use A. The framework platform 111 may recognize each of the feeds to include metadata indicating that the data relates to user A. Then, the framework platform 111 may identify another, second data feed of blood sugar levels not associated with any user, where the data is nearly identical to that of the previously described blood sugar level data feed. Here, the framework platform 111 may associate the second data feed with the data relating to user A since health afflictions of user A may be similar to that of the unidentified user. As such, the framework platform 111 may associate the metadata of the second data feed with that of the blood pressure data feed and the first blood sugar level data feed and build the metadata framework to accommodate the association. In doing so, the three data feeds may inform users and the framework platform 111 of related health issues and provide ability to extrapolate health consequences amongst users.

Regarding distributed data tagging, the framework platform 111 may identify changes to metadata. Changes may include, for instance, the previously discussed associations, as well as changes due to newly received metadata from new content items, dynamic metadata, or a combination thereof. Then, the framework platform 111 may determine the accuracy of metadata in describing associated content items. In one embodiment, the framework platform 111 may promote usage of accurate, well-designed metadata by tagging new content items with the metadata. In tagging new content items with the metadata, the framework platform 111 populates new fields in the metadata framework based on the tags, thereby enhancing the capability to retrieve and analyze relevant content items.

In one embodiment, sensor platform 101 may be implemented as part of a cloud service. Sensor platform 101 may also, in some embodiments, provide data conversion into one or more universal formats compatible with applications. Such capability in the sensor platform 101 supports vertical integration from sensor devices 103a-103n (or sensor devices 103) to the sensor platform 101, and to applications 105a-105n (or applications 105). The vertical integration may facilitate collective analysis of content items and metadata to develop the metadata framework.

In certain embodiments, vertical integration may provide seamless interaction between the sensor platform 101, sensor devices 103, and applications 105. Such vertical integration may involve functionally combining different components at various levels or forms of data acquisition under a centralized ecosystem created by sensor platform 101. In one embodiment, vertical integration in system 100 involves the sensor platform 101 building unique capability to integrate sensor device 103a with applications 105 via universal data formatting and device discovery. In other words, sensor devices 103 are endpoints with embedded intelligence allowing the sensor device 103a, for example, to provide data to the sensor platform 101. The sensor platform 101, in turn, contains intelligence specific to permitting applications 105 to use data from the sensor platform 101. Sensor platform 101 is thus a central service relative to a collection of sensor devices 103 that provides the means of building communications intelligence between sensor device 103a (or direct sensors) and applications 105, all existing within a particular ecosystem. In one embodiment, the intelligence includes converting data into universal formats, for example, converting data obtained from sensor device 103a into a universal format, then interfacing with applications 105 that use data in the universal format.

In one embodiment, computing device 107 may convey sensor information to the sensor platform 101 for the sensor platform 101 to process and store. As used herein, a “sensor device” refers to a separate physical device that interfaces with a computing device 107 (as in sensor device 103a) or a single hardware that has the functionality of a sensor and a computer (e.g., a smart phone with a sensor application). It is noted that each of the sensor devices 103 may utilize a computing device 107 (e.g., mobile phone, laptop, or netbook, etc.) to communicate over a personal area network (PAN) (not shown) or a local area network (not shown).

In one embodiment, the framework platform 111 is maintained by a service provider network 119 and observes content items and associated metadata directly from the sensor devices 103, as well as from usage of the content items by applications 105. In one embodiment, the framework platform 111 determines new metadata appropriate for received content items based on a metadata storage organization comprising a framework, as well as observed metadata manipulations observed in content item and metadata use. The framework platform 111 may further validate framework structure and inferences from manipulations based on interactions between newly tagged content items. In one embodiment, the framework platform 111 may then provide a flexible metadata framework that responds to and reflects how content items relate to each other, thus providing greater accuracy and insight for data retrieval and analysis.

By way of example, the sensor devices 103 may be any type of sensor. In certain embodiments, the sensor devices 103 may include, for example a network detection sensor for detecting wireless signals or network data, receivers for different short-range communications (e.g., Bluetooth, WiFi, near field communication etc.) and the like.

By way of example, sensor device 103a is coupled to the computing device 107, which can be any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the computing device 107 can support any type of interface to the user (such as “wearable” circuitry, etc.). In one embodiment, the applications 105 may be any type of application that is executable at the computing device 107.

The service provider network 119 can interact with one or more networks, such as a telephony network 113, a wireless network 115, and/or a data network 117. The service provider network 119 can include one or more applications 105 that provide services to the service provider network 119. In one embodiment, the applications 105 may include health care applications offering various measurement services to monitor and ensure consumer health. Such services may include measuring sleep quality or patterns, exercise levels, blood pressure, blood sugar levels, weight, heart rate, dietary intake, mood, etc. The services may further include aggregating user measurements or helping users share the measurements, either with other users or with medical professionals.

Additional services associated with, for example, the telephony network 113, the wireless network 115, or the data network 117, may also interact with the sensor platform 101, the applications 105, and the framework platform 111. By way of example, a service associated with the data network 117 can store information to files associated with the applications 105 of the service provider network 119. The sensor platform 101 can then analyze the information from the service stored in the one or more files, for example, to supply the applications 105 with insight regarding the stored files. For instance, sensor platform 101 may analyze collective file data to provide an application 105a with a notification regarding a user's improving medical condition in light of increased exercise. Furthermore, the framework platform 111 may process the information from the service associated with the data network 117 to modify storage and access to the files.

For illustrative purposes, the networks 113-119 may be any suitable wireline and/or wireless network, and be managed by one or more service providers. For example, telephony network 113 may include a circuit-switched network, such as the public switched telephone network (PSTN), an integrated services digital network (ISDN), a private branch exchange (PBX), or other like network. Wireless network 115 may employ various technologies including, for example, code division multiple access (CDMA), enhanced data rates for global evolution (EDGE), general packet radio service (GPRS), mobile ad hoc network (MANET), global system for mobile communications (GSM), Internet protocol multimedia subsystem (IMS), universal mobile telecommunications system (UMTS), etc., as well as any other suitable wireless medium, e.g., microwave access (WiMAX), wireless fidelity (WiFi), satellite, and the like. Meanwhile, data network 117 may be any local area network (LAN), metropolitan area network (MAN), wide area network (WAN), the Internet, or any other suitable packet-switched network, such as a commercially owned, proprietary packet-switched network, such as a proprietary cable or fiber-optic network.

Although depicted as separate entities, networks 113-119 may be completely or partially contained within one another, or may embody one or more of the aforementioned infrastructures. For instance, the service provider network 119 may embody circuit-switched and/or packet-switched networks that include facilities to provide for transport of circuit-switched and/or packet-based communications. It is further contemplated that networks 113-119 may include components and facilities to provide for signaling and/or bearer communications between the various components or facilities of system 100. In this manner, networks 113-119 may embody or include portions of a signaling system 7 (SS7) network, or other suitable infrastructure to support control and signaling functions.

According to exemplary embodiments, end user devices may be utilized to communicate over system 100 and may include any customer premise equipment (CPE) capable of sending and/or receiving information over one or more of networks 113-119. For instance, voice terminal may be any suitable plain old telephone service (POTS) device, facsimile machine, etc., whereas mobile device (or terminal) may be any cellular phone, radiophone, satellite phone, smart phone, wireless phone, or any other suitable mobile device, such as a personal digital assistant (PDA), pocket personal computer, tablet, customized hardware, etc. Further, computing device may be any suitable computing device, such as a VoIP phone, skinny client control protocol (SCCP) phone, session initiation protocol (SIP) phone, IP phone, personal computer, softphone, workstation, terminal, server, etc.

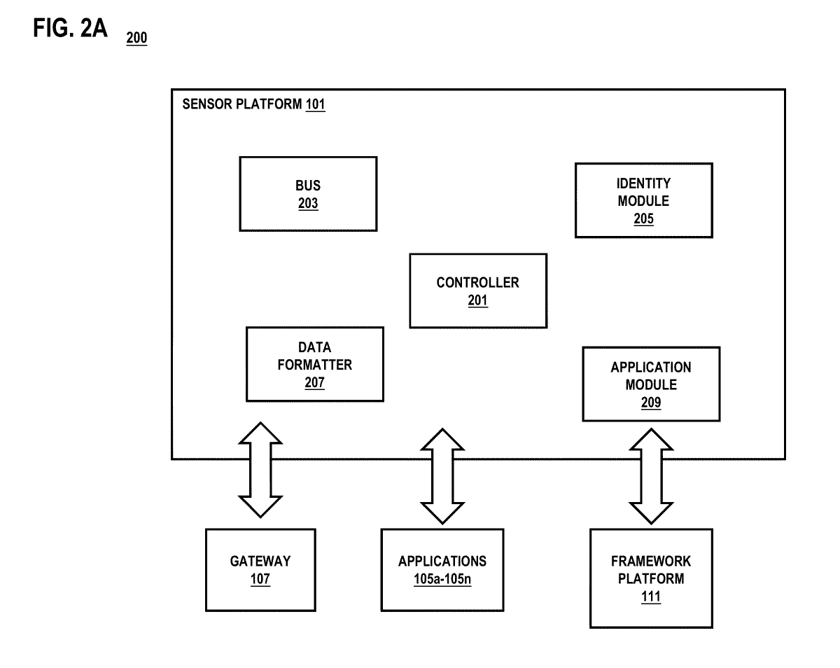

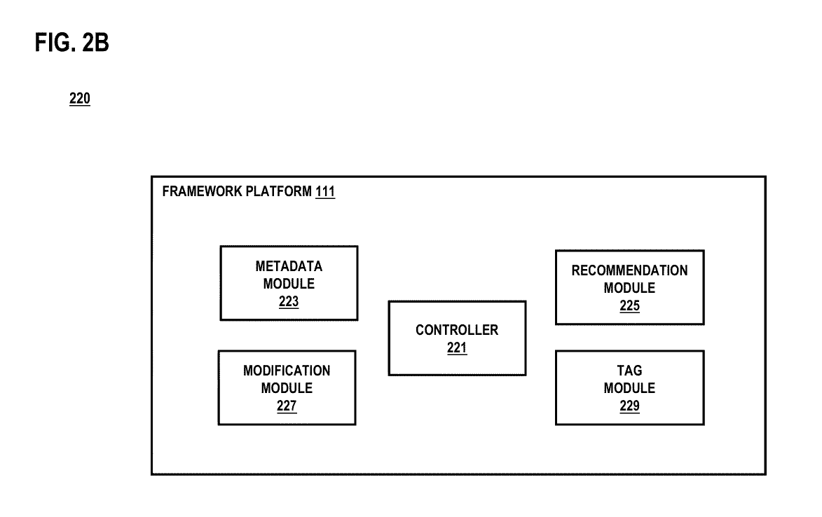

FIG. 2A is a diagram of a sensor platform capable of registering various sensor devices and receiving data intelligently, according to one embodiment. The sensor platform 101 contains a controller 201, bus 203, identity module 205, data formatter 207, and application module 209. The sensor platform 101 may receive sensor information and convey the information to applications 105. In one embodiment, the sensor platform 101 may process the data to facilitate use by the applications 105. The sensor devices 103 themselves or the computing device 107 may supply the sensor platform 101 with data and metadata from various sensor devices 103. The framework platform 111 may ensure that data supplied by the sensor platform 101 are accurate and ideal for the functions of applications 105.

The controller 201 performs control logic functions and facilitates coordination among the other components of sensor platform 101. In one embodiment, the bus 203 is a communication vehicle that transmits data and metadata sensor devices 103, applications 105, and all the various components within the sensor platform 101. The identity module 205 may register new pairings between user devices and sensor devices 103, and store information for current such pairings. An example embodiment of the identity module 205 may include an identification system to provide assurance of associations between users and user devices, as well as security for transmitted sensor data. The identification system may include a security application that facilitates strong authentication to web sites, applications, and networks by providing access only after providing a registered identification system identity. According to one embodiment, the identification system registration process may provide further security by requiring an activation code. Registration and authentication may occur several times over the course of the data identification system events without the applications being disrupted from their normal operation. This authentication may be controlled by a proxy mechanism which is part of the sensor platform 101. In one embodiment, the identity module 205 may contribute to metadata associated with sensor information.

The data formatter 207 may receive data in various formats and convert this data into a universal format usable in applications 105. The data formatter 207 may have a different connector for different types of data streams. According to one embodiment, the data formatter 207 may include one connector dedicated to a sensor data stream and another connector dedicated to, e.g., a video data stream. Each of these connectors may feed into a respective formatter depending on the original data format. Once the data formatter 207 converts the data feeds into a universal format, a stream controller may then provide the converted data and metadata into a connector that feeds the newly formatted data onto the bus 203. Bus 203 may subsequently distribute the converted data to the applications 105. The application module 209 may manage the various applications interacting with the sensor platform 101 and monitor data usage, tracking applications that fall to misuse and allotting system resources based on application activity.

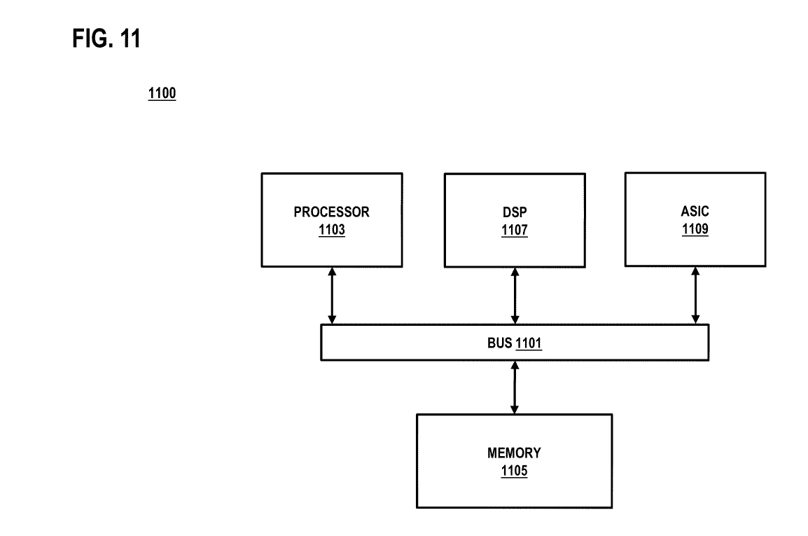

FIG. 2B is a diagram of a framework platform capable of determining a metadata organization framework, according to one embodiment. Framework platform 111 may comprise computing hardware (such as described with respect to FIG. 11), as well as include one or more components configured to execute the processes described herein for providing the adaptive framework processing services of system 100. In one implementation, framework platform 111 includes controller 221, metadata module 223, recommendation module 225, modification module 227, and tag module 229. Sensor devices 103 associated with user devices and the framework platform 111 may access the bus 203 that is in contact with a sensor platform 101. While specific reference will be made to this particular implementation, it is also contemplated that bus 203 may embody many forms and include multiple and/or alternative components. For example, it is contemplated that the components of the bus 203 may be combined, located in separate structures, or at separate locations.

In one embodiment, the controller 221 and metadata module 223 may determine metadata associated with content items. For example, the controller 221 and metadata module 223 may receive, from the sensor devices 103, content items representing sensor information. Then, the controller 221 and metadata module 223 may determine metadata associated with the content items. For example, the controller 221 and metadata module 223 may determine first metadata associated with a first content item and a second metadata associated with a second content item, multiple metadata associated with a single content item, or various metadata associated with various content items. The metadata may include fixed and/or dynamic metadata. Then, the controller 221 and recommendation module 225 may recommend metadata based on the determine metadata. For example, the controller 221 and recommendation module 225 may determine more metadata based on metadata already associated with the determined metadata. For example, the controller 221 and recommendation module 225 may determine a third metadata based on the first metadata and the second metadata. The controller 221 and recommendation module 225 may also determine a third metadata from various collected metadata from individual or collective content items. In one scenario, the controller 221 and recommendation module 225 may determine the third metadata from known, existing metadata based on previous content items or incoming content items. In another scenario, the controller 221 and recommendation module 225 may create new metadata describing connections between metadata.

In one embodiment, the controller 221 and modification module 227 may determine a change to a metadata framework based, at least in part, on the third metadata. For example, the controller 221 and modification module 227 may determine a storage structure for metadata that comprises a framework for metadata storage. In one embodiment, the controller 221 and modification module 227 may determine hierarchies of metadata or relationships between various metadata. Then, the controller 221 and modification module 227 may also adapt the framework to reflect the hierarchies and relationships. For example, a hierarchy of metadata may include insight into usage, prominence, popularity, of metadata. In another embodiment, the controller 221 and modification module 227 may develop more levels of granularity in the metadata framework or alter a previously-determined level for a certain metadata, based on collected sensor information.

In a further embodiment, the hierarchies or relationships may comprise means of ordering metadata. For example, the controller 221 and modification module 227 determine associations between metadata and order the associations into hierarchies reflecting the relationships between metadata and individual metadata characteristics. In another embodiment, the controller 221 and modification module 227 may determine content item organizations and determine the orders relative to the content item organizations. For example, the controller 221 may maintain relationships between metadata independently from storage of content items, but metadata and content item organization may impact retrieval of content items from the storage organizations. For instance, insightful and accurate metadata orders may facilitate ease of retrieval of relevant content items and data analysis. The controller 221 and modification module 227 may modify the order, organization, or both, based on newly determined metadata, metadata associations, and content items. In particular, the controller 221 and modification module 227 may determine a change in metadata, for example, a manipulation of a metadata. Then, the controller 221 and modification module 227 may modify the metadata orders, content item organization, or a combination thereof based, at least in part, on the change.

In one embodiment, the controller 221 and tag module 229 may associate a determined metadata with a new content item, for example, by tagging the content item with the determined metadata. For example, the controller 221 and tag module 229 may determine from a change in a metadata framework, that a metadata is relevant to a newly received content item. For example, the content item may have two metadata tags and the sensor platform 101 may store the content item based on the two metadata tags. Then, the sensor platform 101 may detect a change made by the controller 221 and modification module 227 where the storage based on the two metadata tags shows an indication of a relationship to another metadata. From this indication, the controller 221 and tag module 229 may tag the content item with this metadata. By extension, the controller 221 may then view the content item as being related to the most recent metadata tag and analyze the content item along with other similarly tagged content items.

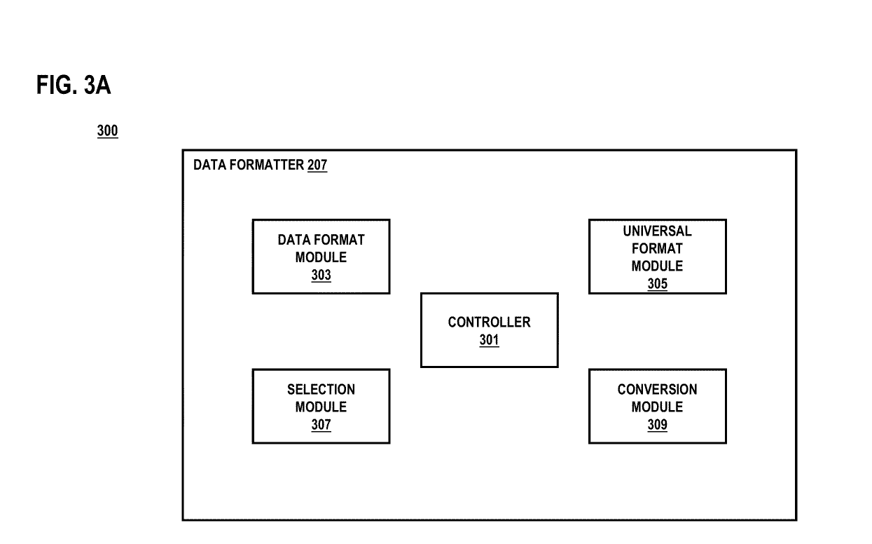

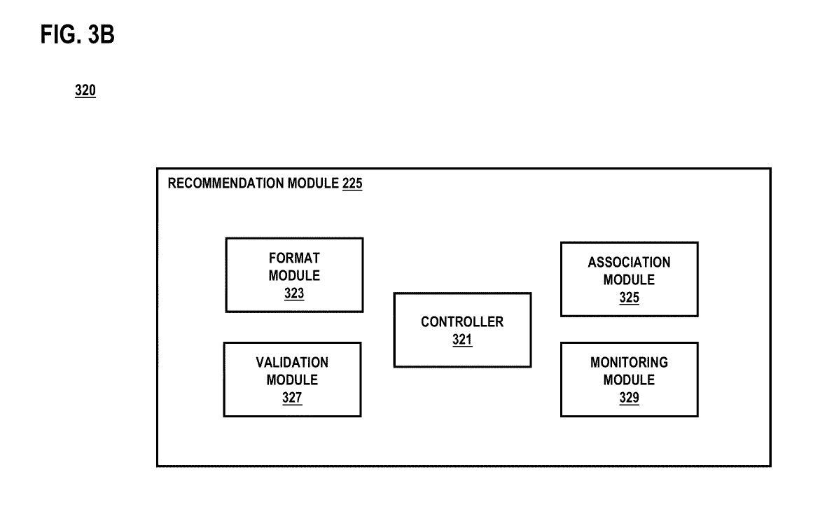

FIG. 3A is a diagram of the data formatter 207 capable of converting raw sensor data into a common format, according to one embodiment. Data formatter 207 may comprise computing hardware (such as described with respect to FIG. 11), as well as include one or more components configured to execute the processes described herein for providing the adaptive framework processing services of system 100. In converting the raw sensor data into a common format, the data formatter 207 facilitates data comparison and therefore provides the ability to determine associations between metadata. In one implementation, data formatter 207 includes controller 301, data format module 303, universal format module 305, selection module 307, and conversion module 309. In one embodiment, the controller 301 and the data format module 303 may determine the data format of received raw sensor data. The universal format module 305 may contain a collection of universal formats. In one embodiment, the system 100 may include several universal data formats formulated for various types of files. For example, text data and media data may include a number of different types of files for each type of input. The universal data format may be universal within the realm of media input. The controller 301 and selection module 307 may then determine a universal format that corresponds to the raw metadata. Then, the controller 301 and conversion module 309 may convert the raw sensor data into the universal format determined by the selection module 307.

FIG. 3B is a diagram of the recommendation module 225 capable of determining changes to metadata or metadata frameworks, according to one embodiment. Recommendation module 225 may comprise computing hardware (such as described with respect to FIG. 11), as well as include one or more components configured to execute the processes described herein for providing the adaptive framework processing services of system 100. In one implementation, recommendation module 225 includes controller 321, format module 323, association module 335, validation module 337, and monitoring module 339. In one embodiment, the controller 301 and the format module 323 may interact with the data formatter 207 to convert metadata formats where necessary. The controller 321 and format module 323 may additionally determine metadata standards or provide for metadata standardization within a set of metadata storage. In one embodiment, the controller 321 and format module 323 may facilitate the process of determining similarities or trends between metadata by converting the metadata into formats and/or standards that allow for metadata comparison.

In one embodiment, the controller 321 and association module 325 may determine associations between metadata and determine more metadata based on the associations. For example, the controller 321 and association module 325 may determine associations between a first metadata and a second metadata, then determine a third metadata based on the one or more associations. In another embodiment, the controller 321 and validation module 327 may validate the newly determined metadata (for instance, the third metadata), based on newly received content items representing sensor information. For example, the controller 321 and validation module 327 may verify that later-received sensor information is consistent with or confirms the relationship between the first, second, and third metadata. In doing so, the controller 321 and validation module 327 may determine well-designed metadata or determine the completeness, relevance, and/or canonicity of metadata. The controller 321 and monitoring module 329 may determine modifications to content items, metadata, content item or metadata usage, and use the modifications to enforce or form new associations between metadata. By extension, the controller 321 and monitoring module 329 may also affect the metadata framework based on observations on the modifications.

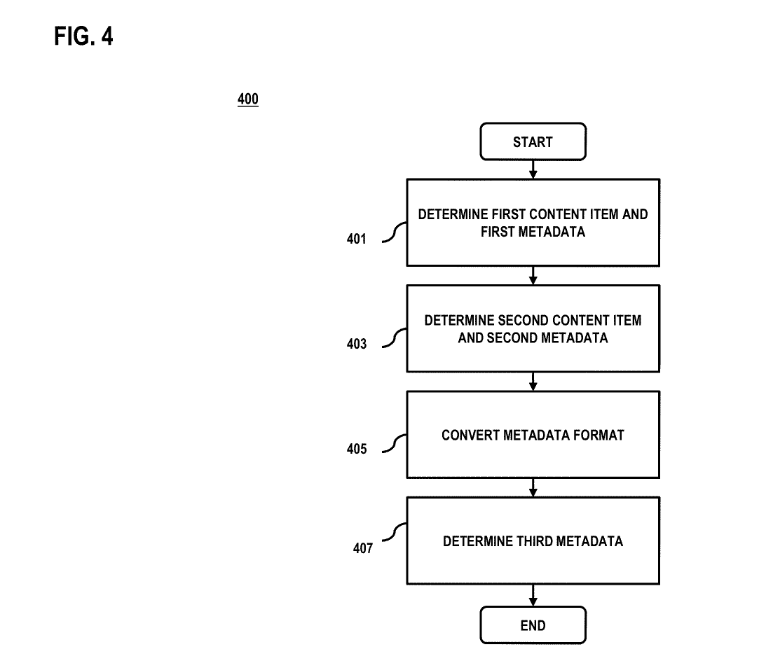

FIG. 4 is a flowchart of a process 400 for creating metadata, according to one embodiment. In steps 401 and 403, the controller 221 may determine a first metadata associated with a first content item representing sensor information and a second metadata associated with a second content item representing sensor information. For example, the controller 221 may determine a number, “86,” as a first content item. The number may be tagged with a first metadata, “temperature.” The controller 221 may then receive a second content item, “80”, tagged with a second metadata, “blood pressure.” In one embodiment, the controller 221 may determine a first format associated with the first metadata, the second metadata, or a combination thereof and convert the first format to a second format that includes a data format used by one or more sensors, and/or one or more applications, per step 405. In one embodiment, the conversion may aid the controller 221 (as in step 407), whereby the controller 221 may determine a third metadata based on the first metadata and the second metadata. For example, the controller 221 may take “outdoor temperature” and “blood pressure” and create a third metadata, “season.” In such a scenario, the controller 221 may then observe correlations or fluctuations in blood pressure relative to weather or throughout the course of a year relative to seasonal changes.

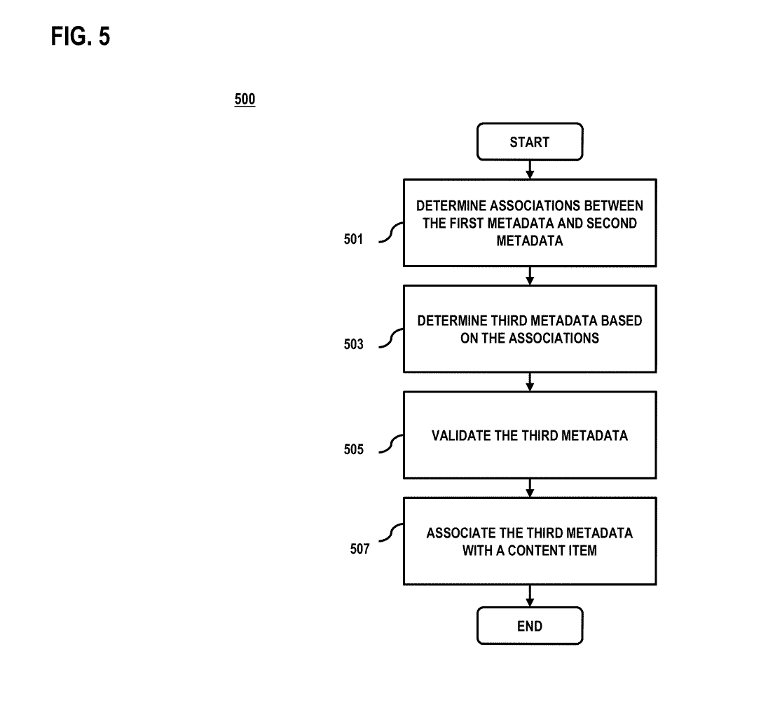

FIG. 5 is a flowchart of a process 500 for generating and validating new metadata to ensure quality metadata, according to one embodiment. For example, in step 501, the controller 321 may determine one or more associations between the first metadata and the second metadata. For example based off the previous temperature and blood pressure, the controller 321 may determine a correlation between temperature and blood pressure. The controller 321 may then determine this correlation to be indicative of an association, rather than determining the first content item and second content item (or first metadata and second metadata, respectively) to be unrelated. Once the controller 321 establishes the associations, the controller 321 may determine the third metadata based on the one or more associations (step 503). Then, the controller 321 may validate the third metadata based on one or more content items representing sensor information (step 505). For instance, as the controller 321 receives more temperature and blood pressure measurements, the controller 321 may strengthen or weaken the previously determined correlation or association. The controller 321 may take stronger associations to be indication of validation for the third metadata. Once the third metadata is reasonably validated, the controller 321 may associate the third metadata with a third content item, and so proliferate the use of the new, valid metadata (step 507). The controller 221 may also perform all of these steps, either in their entirety, or in part.

Although the above process is described with respect to metadata being derived from two other metadata, it is noted that the derived metadata can be formed using greater than two metadata. Also, it is contemplated that the derivation process can be iterative. That is, the final metadata that is generated can be derived from other derived metadata.

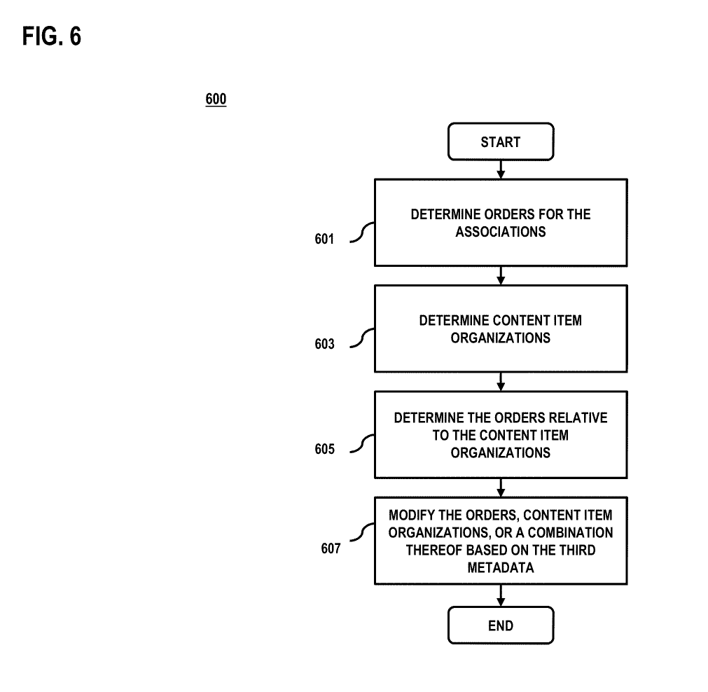

FIG. 6 is a flowchart of a process 600 for modifying a framework to accommodate new metadata, according to one embodiment. For example in step 601, the controller 221 may determine one or more orders for the one or more associations among multiple metadata. For example, orders may specify a hierarchy or some structural organization to the associations. In one scenario, the controller 221 may take the orders to be a hierarchy of association strength. Alternately, the controller 221 may structure the orders according to how probative an association may be to the detection of a medical condition. In one instance, the controller 221 may further determine one or more associations based on the one or more orders. For instance, once the order is created, the controller 221 may gain insight into even more possible associations.

For step 603, the controller 221 determines one or more content item organizations. For example, the controller 221 may determine that blood pressure is organized in accordance with a user medical profile while temperature may go into an organization chronicling context information. In step 605, the controller 221 determines the one or more orders for the one or more associations among various metadata (e.g., a first metadata, a second metadata, a third metadata, or a combination thereof) relative to the one or more content item organizations. In one embodiment, a first metadata might be “spring,” a second metadata, “winter,” and a third metadata, “allergies.” For example where orders are based on association strength, the controller 221 may determine association between the metadata “spring” and “allergies” to be high in the order whereas association between the metadata “winter” and “allergies” is low in the order (due to their respective association strength). Content item organizations for this instance may include context information and user medical profiles. The controller 221 may process and analyze collective information given by the orders regarding allergies and content item organizations with medical profiles to determine that users that have allergies also tend to have asthma. Based on this analysis, the controller 221 may add to the order, an association between “spring” and “asthma” to observe whether asthma symptoms are exacerbated in with the onset of spring similar to how some allergies arise with spring. Similarly with a scenario where orders are built around asthma detection, controller 221 may modify content item organizations to categorize a user originally diagnosed with only allergies, into a user profile grouping for patients that may also have asthma. As such, the controller 221 may modify the one or more orders, the one or more content item organizations, or a combination thereof based on the determination of the third metadata (step 607).

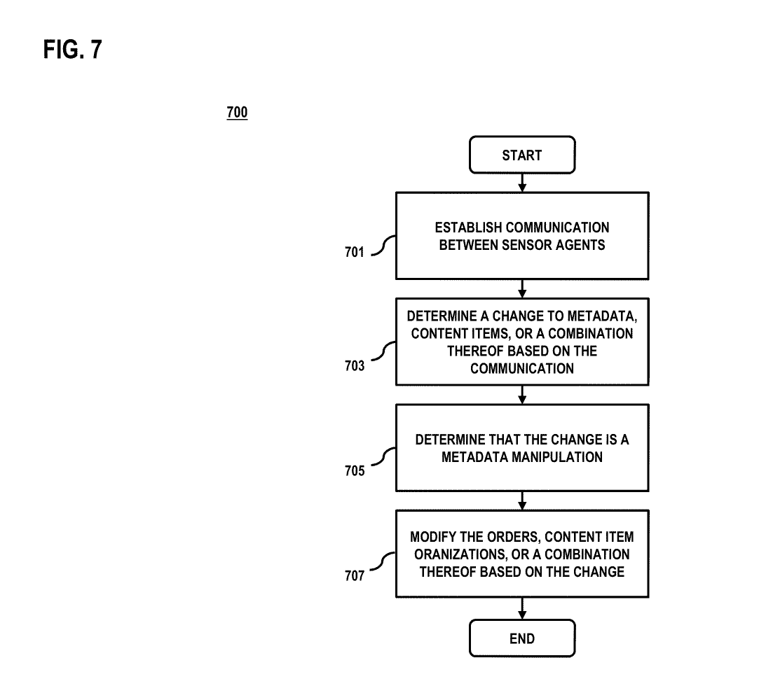

FIG. 7 is a flowchart of a process 700 for modifying a framework based on metadata manipulation, according to one embodiment. For example, controller 321 may provide means to detect metadata manipulation first by establishing communication between one or more sensors (step 701). The communication may include exchange of information including metadata between the sensors, where data arriving from one sensor device 103a may comprise a first content item, and data from another sensor device 103b (i.e., a second content item). Communication between the sensor devices 103a and 103b may facilitate comparison of content items from the respective sensor devices. For example, a temperature sensor device may initiate data retrieval from a blood pressure monitor sensor device once temperatures exceed a threshold temperature where studies have shown temperature to relate to a rise in blood pressure.

Then, controller 321 may determine a change to the first metadata, the second metadata, the first content item, the second content item, or a combination thereof based on the communication between the one or more sensors (step 703). Next, the controller 321 may determine that the change is a metadata manipulation (step 705). For example, a “change” can include categorizing metadata. For instance, the controller 321 may contain various metadata. A “change” may involve the controller 321 determining ways in which the various metadata fit into the orders as dictated by controller 221. Fitting metadata into the orders may constitute categorizing the metadata. For example, one scenario may include blood pressure readings as first content items, and temperature readings as second content items. The blood pressure readings may increase to the point of triggering a metadata, “risk.” Then, the controller 321 may determine a temperature reading at which point “risk” was first perceived in blood pressure readings and categorize that determined temperature under an order for “factors contributing to high blood pressure.”

In another example however, the controller 321 may determine that simply categorizing or storing metadata does not constitute a “manipulation,” whereas re-categorizing metadata or generating new metadata or based on existing metadata would be manipulation. The controller 321 may govern what actions (and to what degree such actions are executed) to interpret as metadata manipulation. Furthermore, the controller 321 may continually incorporate more actions or fewer actions to define as metadata manipulations based on observations of content item and metadata interactions within the system 100. Lastly, the controller 321 may modify the one or more orders, the one or more content item organizations, or a combination thereof based on the change to the first metadata, the second metadata, the first content item, the second content item, or a combination thereof (step 707).

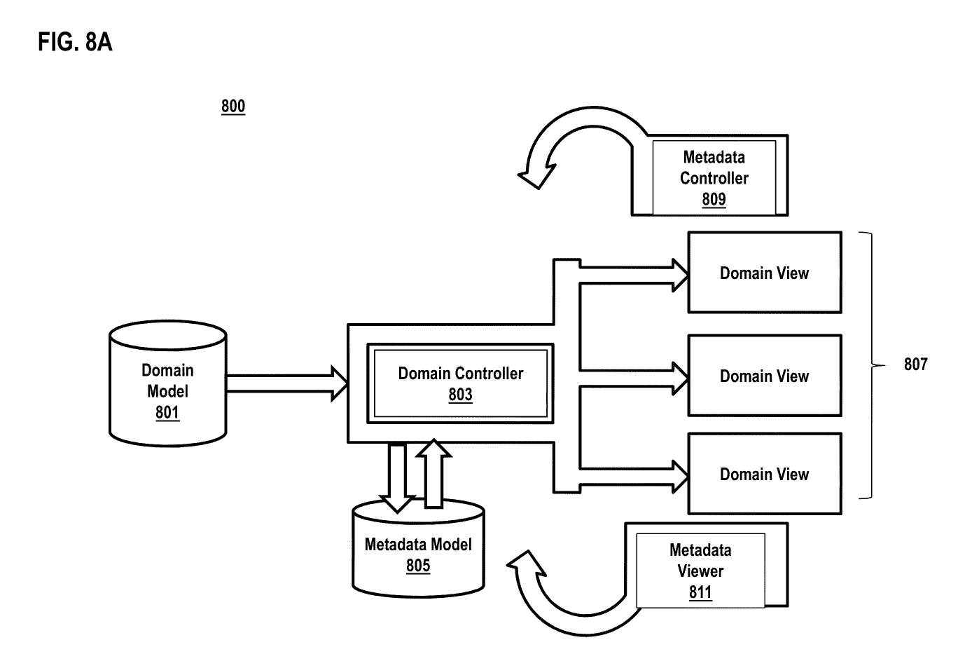

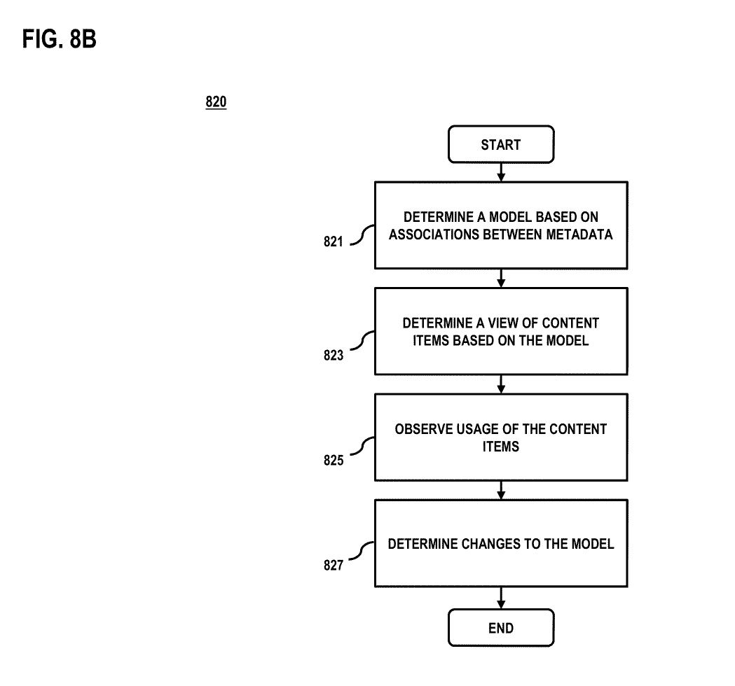

FIG. 8A is a diagram of an embodiment of a metadata framework 800 where content items are abstracted into different metadata views, depending on the purposes of content item retrieval. For example, domain model 801 may produce a first view of a content item and associated metadata. In doing so, the domain model 801 produces an ordered view of relationships and states of metadata tags. Domain controller 803 may then process the content item along with the associated metadata. For example, domain controller 803 may receive input from metadata model 805 that provides metadata associations or models of metadata relating to metadata or content item usage. For example, models of metadata usage may include models of patterns or trends relating to how metadata is manipulated as well as how content items with certain metadata are used in conjunction with each other. Based on information provided by the metadata model 805, the domain controller 803 may output various domain views 807. For example, domain views 807 may present domain-specific metadata with improved search capabilities and insights, either into their related content items or ties between metadata.

In one embodiment, the metadata framework 800 may further include a metadata controller 809 and metadata viewer 811. For example, the metadata controller 809 may observe changes in metadata manipulation or content items and update the metadata model 805. In other words, the metadata controller 809 may observe how well models reflect the metadata associations they aim to represent. Then, the metadata controller 809 may refine models or metadata associations to build and refine the models. For instance, the metadata controller 809 may adapt and groom models based on a time-varying domain model and viewers. In one scenario, viewers may include users accessing or looking to search for content items. The metadata controller 809 may hone models in the metadata model 805 for accuracy and insight into retrieving the content items a user had in mind and increasingly abstracting content items with metadata accurately. For example, the metadata controller 809 may refine models by adjusting ranks and orders of metadata associations to optimally reflect evolving usage of underlying content items and metadata associated with the data. For instance, associations between metadata “A” and metadata “B” may increasingly grow strong, whereas metadata “A” and metadata “C” once had a stronger association than metadata “A” and metadata “B.” The metadata controller 809 may sense this transition in received metadata and change an order of strong associations. Where metadata “A” and metadata “C” were once more strongly linked, the metadata controller 809 may shift models such that metadata “A” and metadata “B” are shown as more strongly linked than metadata “A” and metadata “C.” In one embodiment, the metadata viewer 811 may provide a view into metadata associated with content items in order to directly look into how a content item may be characterized. In doing so, the system 100 or users may modify the metadata or simply better understand metadata framework development with respect to a given content item.

FIG. 8B is a flowchart of a process 820 for abstracting content items into different metadata views and changing models of metadata relating to content item usage, according to one embodiment. For example, the process 820 may illustrate an exemplary process flow associated with the metadata framework shown in FIG. 8A. At step 821, the metadata controller 809 may determine a model based on one or more associations between metadata. For example, the one or more associations between metadata may be organized into a model characterizing how various metadata is related. At step 823, the domain model 801, the domain controller 803, and/or the metadata controller 809 may then determine a view of one or more content items in the context of an order, where the view is based on the model. For instance, a metadata controller 809 may determine metadata associated with a content item. Then, the metadata controller 809 may employ the model to determine metadata related to the metadata associated with the content item. From there, the metadata controller 809 may frame the content item in the context of the metadata associated with the content item and metadata from the model to produce a view of the content item in the context of an order. For example, the view may include domain-specific metadata and a characterization of the content item in the framing of the model.

In one embodiment, at step 825, the metadata controller 809 may observe usage of the content items. For example, step 825 may include observing manipulation of content items. Step 825 may also include monitoring how various content items or metadata interact. For example, if two content items are found to be closely related, the metadata controller 809 may infer that metadata associated with the two content items are also closely related or significantly overlap. If two content items are nearly mutually exclusive, then metadata associated with the two content items may also not be closely associated. The metadata controller 809 may then determine one or more changes to the model based, at least in part, on the observed usage, at step 827. For example, the metadata controller 809 may hone the model based on a time-varying domain model and viewer behavior. In one embodiment, the one or more changes may include changes to the one or more rankings within the model to optimize relevance between the model and the one or more content items.

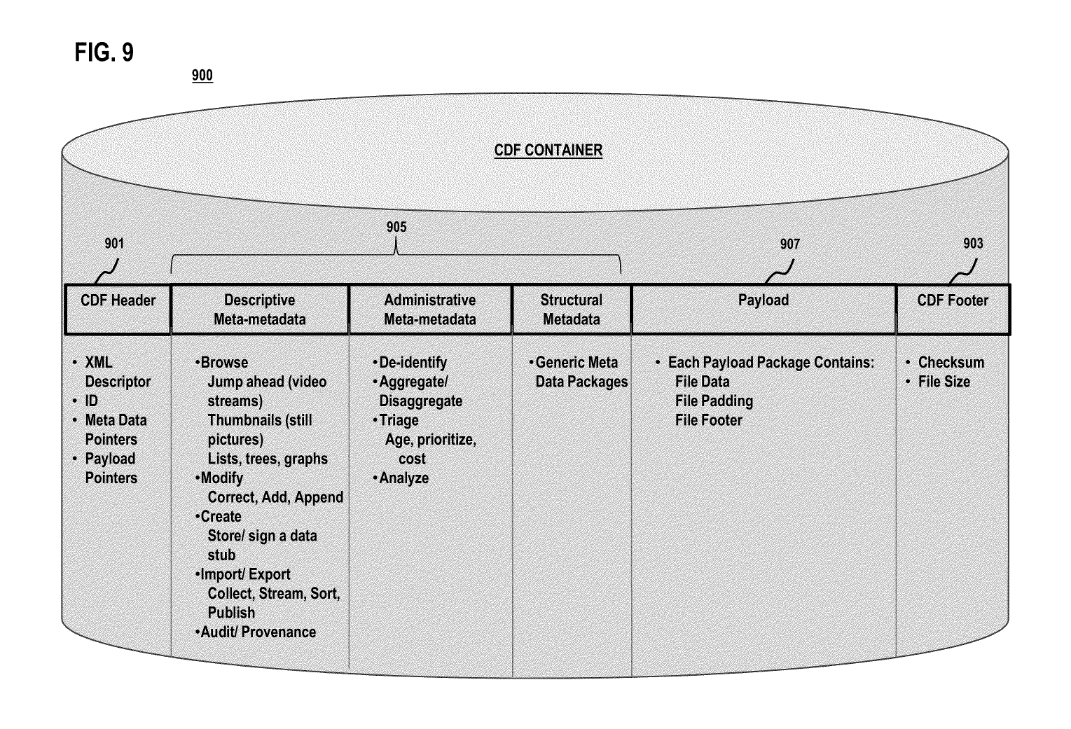

FIG. 9 is a diagram of a metadata view 900, specifically one including a common data format (CDF) for content items and metadata, in one embodiment. This metadata view 900 may be comprised of a CDF container. In one embodiment, content items may include a CDF header 901 and footer 903. The CDF header 901 may provide content item descriptors that permit comparison of the data, given the standard format. For example, the CDF header 901 may include a deployment descriptor, identification code, metadata pointers, and payload pointers. A deployment descriptor may include, for instance, an Extensible Markup Language (XML) descriptor. An identification code may include a universal identification that serves to identify a user or user device across multiple systems, networks, services, and/or applications. The CDF footer 903 may include checksum or file size data to facilitate transmission, storage, and use of a content item. The content item may include a metadata package 905.

In one embodiment, the metadata package 905 may be a generic metadata package. In another embodiment, the metadata package 905 may include descriptive meta-metadata, administrative, and structural metadata. Different combinations of this meta-metadata and metadata may comprise a generic metadata package. Descriptive meta-metadata may include information facilitating resource discovery and identification, for example, “browse”, “modify”, “create”, “import/export”, and/or “audit/provenance.” Administrative meta-metadata may include data supporting resource management within a collection, for instance, “de-identify”, “aggregate/disaggregate”, “triage”, and “analyze.” Structural metadata may pertain to information binding various components of a complex information object together. The content item itself may be part of a payload 907. In one embodiment, the payload 907 may contain file data, file padding, and a file footer. Defining the payload 907 to a standard may provide for consistency in content item storage and organization within a system.

The processes described herein for providing for providing a metadata management framework may be implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

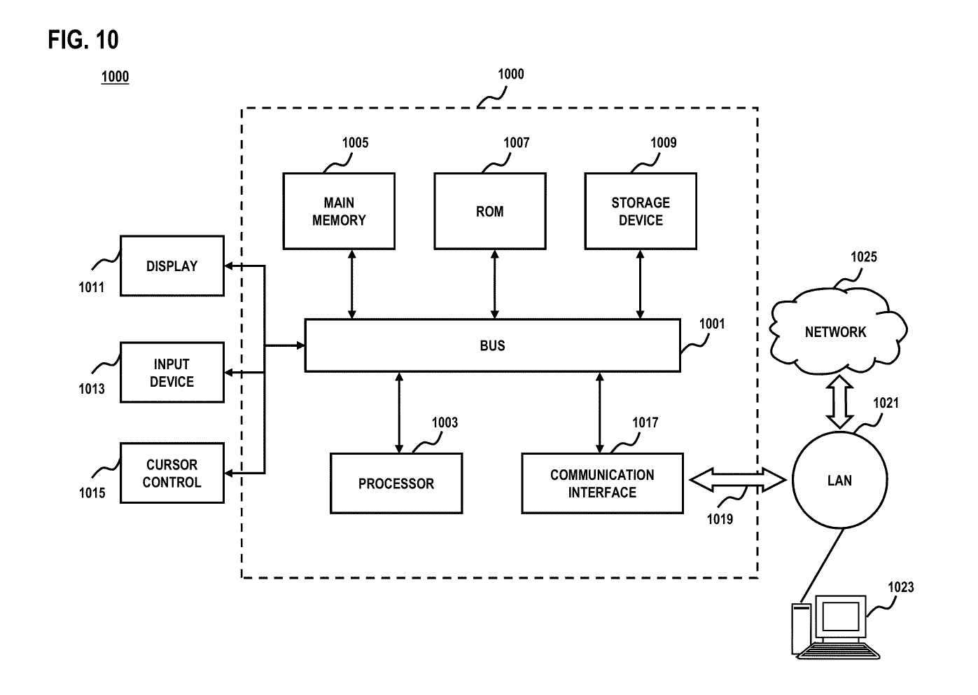

FIG. 10 is a diagram of a computer system that can be used to implement various embodiments. The computer system 1000 includes a bus 1001 or other communication mechanism for communicating information and a processor 1003 coupled to the bus 1001 for processing information. The computer system 1000 also includes main memory 1005, such as a random access memory (RAM) or other dynamic storage device, coupled to the bus 1001 for storing information and instructions to be executed by the processor 1003. Main memory 1005 can also be used for storing temporary variables or other intermediate information during execution of instructions by the processor 1003. The computer system 1000 may further include a read only memory (ROM) 1007 or other static storage device coupled to the bus 1001 for storing static information and instructions for the processor 1003. A storage device 1009, such as a magnetic disk or optical disk, is coupled to the bus 1001 for persistently storing information and instructions.

The computer system 1000 may be coupled via the bus 1001 to a display 1011, such as a cathode ray tube (CRT), liquid crystal display, active matrix display, or plasma display, for displaying information to a computer user. An input device 1013, such as a keyboard including alphanumeric and other keys, is coupled to the bus 1001 for communicating information and command selections to the processor 1003. Another type of user input device is a cursor control 1015, such as a mouse, a trackball, or cursor direction keys, for communicating direction information and command selections to the processor 1003 and for controlling cursor movement on the display 1011.

According to an embodiment of the invention, the processes described herein are performed by the computer system 1000, in response to the processor 1003 executing an arrangement of instructions contained in main memory 1005. Such instructions can be read into main memory 1005 from another computer-readable medium, such as the storage device 1009. Execution of the arrangement of instructions contained in main memory 1005 causes the processor 1003 to perform the process steps described herein. One or more processors in a multi-processing arrangement may also be employed to execute the instructions contained in main memory 1005. In alternative embodiments, hard-wired circuitry may be used in place of or in combination with software instructions to implement the embodiment of the invention. Thus, embodiments of the invention are not limited to any specific combination of hardware circuitry and software.

The computer system 1000 also includes a communication interface 1017 coupled to bus 1001. The communication interface 1017 provides a two-way data communication coupling to a network link 1019 connected to a local network 1021. For example, the communication interface 1017 may be a digital subscriber line (DSL) card or modem, an integrated services digital network (ISDN) card, a cable modem, a telephone modem, or any other communication interface to provide a data communication connection to a corresponding type of communication line. As another example, communication interface 1017 may be a local area network (LAN) card (e.g. for Ethernet™ or an Asynchronous Transfer Mode (ATM) network) to provide a data communication connection to a compatible LAN. Wireless links can also be implemented. In any such implementation, communication interface 1017 sends and receives electrical, electromagnetic, or optical signals that carry digital data streams representing various types of information. Further, the communication interface 1017 can include peripheral interface devices, such as a Universal Serial Bus (USB) interface, a PCMCIA (Personal Computer Memory Card International Association) interface, etc. Although a single communication interface 1017 is depicted in FIG. 10, multiple communication interfaces can also be employed.

The network link 1019 typically provides data communication through one or more networks to other data devices. For example, the network link 1019 may provide a connection through local network 1021 to a host computer 1023, which has connectivity to a network 1025 (e.g. a wide area network (WAN) or the global packet data communication network now commonly referred to as the “Internet”) or to data equipment operated by a service provider. The local network 1021 and the network 1025 both use electrical, electromagnetic, or optical signals to convey information and instructions. The signals through the various networks and the signals on the network link 1019 and through the communication interface 1017, which communicate digital data with the computer system 1000, are exemplary forms of carrier waves bearing the information and instructions.

The computer system 1000 can send messages and receive data, including program code, through the network(s), the network link 1019, and the communication interface 1017. In the Internet example, a server (not shown) might transmit requested code belonging to an application program for implementing an embodiment of the invention through the network 1025, the local network 1021 and the communication interface 1017. The processor 1003 may execute the transmitted code while being received and/or store the code in the storage device 1009, or other non-volatile storage for later execution. In this manner, the computer system 1000 may obtain application code in the form of a carrier wave.

The term “computer-readable medium” as used herein refers to any medium that participates in providing instructions to the processor 1003 for execution. Such a medium may take many forms, including but not limited to non-volatile media, volatile media, and transmission media. Non-volatile media include, for example, optical or magnetic disks, such as the storage device 1009. Volatile media include dynamic memory, such as main memory 1005. Transmission media include coaxial cables, copper wire and fiber optics, including the wires that comprise the bus 1001. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the embodiments of the invention may initially be borne on a magnetic disk of a remote computer. In such a scenario, the remote computer loads the instructions into main memory and sends the instructions over a telephone line using a modem. A modem of a local computer system receives the data on the telephone line and uses an infrared transmitter to convert the data to an infrared signal and transmit the infrared signal to a portable computing device, such as a personal digital assistant (PDA) or a laptop. An infrared detector on the portable computing device receives the information and instructions borne by the infrared signal and places the data on a bus. The bus conveys the data to main memory, from which a processor retrieves and executes the instructions. The instructions received by main memory can optionally be stored on storage device either before or after execution by processor.

FIG. 11 illustrates a chip set 1100 upon which an embodiment of the invention may be implemented. Chip set 1100 is programmed to present a slideshow as described herein and includes, for instance, the processor and memory components described with respect to FIG. 10 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip. Chip set 1100, or a portion thereof, constitutes a means for performing one or more steps of FIGS. 4-7.

In one embodiment, the chip set 1100 includes a communication mechanism such as a bus 1101 for passing information among the components of the chip set 1100. A processor 1103 has connectivity to the bus 1101 to execute instructions and process information stored in, for example, a memory 1105. The processor 1103 may include one or more processing cores with each core configured to perform independently. A multi-core processor enables multiprocessing within a single physical package. Examples of a multi-core processor include two, four, eight, or greater numbers of processing cores. Alternatively or in addition, the processor 1103 may include one or more microprocessors configured in tandem via the bus 1101 to enable independent execution of instructions, pipelining, and multithreading. The processor 1103 may also be accompanied with one or more specialized components to perform certain processing functions and tasks such as one or more digital signal processors (DSP) 1107, or one or more application-specific integrated circuits (ASIC) 1109. A DSP 1107 typically is configured to process real-world signals (e.g., sound) in real time independently of the processor 1103. Similarly, an ASIC 1109 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 1103 and accompanying components have connectivity to the memory 1105 via the bus 1101. The memory 1105 includes both dynamic memory (e.g., RAM, magnetic disk, writable optical disk, etc.) and static memory (e.g., ROM, CD-ROM, etc.) for storing executable instructions that when executed perform the inventive steps described herein to controlling a set-top box based on device events. The memory 1105 also stores the data associated with or generated by the execution of the inventive steps.

While certain exemplary embodiments and implementations have been described herein, other embodiments and modifications will be apparent from this description. Accordingly, the invention is not limited to such embodiments, but rather to the broader scope of the presented claims and various obvious modifications and equivalent arrangements.

What is claimed is:

1. A method comprising:
determining a first metadata associated with a first content item representing sensor information and a second metadata associated with a second content item representing sensor information;
determining a third metadata based on the first metadata and the second metadata; and
associating the third metadata with a third content item.

2. A method according to claim 1, further comprising:
determining a first format associated with the first metadata, the second metadata, or a combination thereof; and
converting the first format to a second format that includes a data format used by a plurality of sensors, a plurality of applications, or a combination thereof.

3. A method according to claim 1, further comprising:
determining one or more associations between the first metadata and the second metadata;
determining the third metadata based on the one or more associations; and
validating the third metadata based on one or more other content items representing sensor information.

4. A method according to claim 1, further comprising:
determining one or more orders for the one or more associations between the first metadata, the second metadata, the third metadata, or a combination thereof; and
determining one or more other associations based on the one or more orders.

5. A method according to claim 4, further comprising:
determining one or more content item organizations; and
determining the one or more orders for the one or more associations between the first metadata, the second metadata, the third metadata, or a combination thereof relative to the one or more content item organizations.

6. A method according to claim 5, further comprising:
modifying the one or more orders, the one or more content item organizations, or a combination thereof based on the determination of the third metadata.

7. A method according to claim 5, further comprising:
determining a change to the first metadata, the second metadata, the first content item, the second content item, or a combination thereof, and
modifying of the one or more orders, the one or more content item organizations, or a combination thereof is based on the change to the first metadata, the second metadata, the first content item, the second content item, or a combination thereof.

8. A method according to claim 7, further comprising:
establishing communication between one or more sensors, and
determining the change to the first metadata, the second metadata, the first content item, the second content item, or a combination thereof based on the communication between the one or more sensors.

9. An apparatus comprising:
at least one processor; and
at least one memory including computer program code for one or more programs,
the at least one memory and the computer program code configured to, with the at least one processor, cause the apparatus to perform at least the following,
determine a first metadata associated with a first content item representing sensor information and a second metadata associated with a second content item representing sensor information;
determine a third metadata based on the first metadata and the second metadata; and
associate the third metadata with a third content item.

10. An apparatus according to claim 9, wherein the apparatus is further caused to:
determine a first format associated with the first metadata, the second metadata, or a combination thereof; and
convert the first format to a second format that includes a data format used by a plurality of sensors, a plurality of applications, or a combination thereof.

11. An apparatus according to claim 9, wherein the apparatus is further caused to:
determine one or more associations between the first metadata and the second metadata;
determine the third metadata based on the one or more associations; and
validate the third metadata based on one or more other content items representing sensor information.

12. An apparatus according to claim 9, wherein the apparatus is further caused to:
determine one or more orders for the one or more associations between the first metadata, the second metadata, the third metadata, or a combination thereof; and
determine one or more other associations based on the one or more orders.

13. An apparatus according to claim 12, wherein the apparatus is further caused to:
determine one or more content item organizations; and
determine the one or more orders for the one or more associations between the first metadata, the second metadata, the third metadata, or a combination thereof relative to the one or more content item organizations.

14. An apparatus according to claim 13, wherein the apparatus is further caused to:
modify the one or more orders, the one or more content item organizations, or a combination thereof based on the determination of the third metadata.

15. An apparatus according to claim 13, wherein the apparatus is further caused to:
determine a change to the first metadata, the second metadata, the first content item, the second content item, or a combination thereof, and
modify the one or more orders, the one or more content item organizations, or a combination thereof is based on the change to the first metadata, the second metadata, the first content item, the second content item, or a combination thereof.

16. An apparatus according to claim 15, wherein the apparatus is further caused to:
establish communication between one or more sensors, and
determine the change to the first metadata, the second metadata, the first content item, the second content item, or a combination thereof based on the communication between the one or more sensors.

17. A system comprising:
a platform configured to determine a first metadata associated with a first content item representing sensor information and a second metadata associated with a second content item representing sensor information,
wherein the platform is further configured to determine a third metadata based on the first metadata and the second metadata, and to associate the third metadata with a third content item.

18. A system according to claim 17, wherein the platform is further configured to:
determine a first format associated with the first metadata, the second metadata, or a combination thereof and
convert the first format to a second format that includes a data format used by a plurality of sensors, a plurality of applications, or a combination thereof.

19. A system according to claim 17, wherein the platform is further configured to:
determine one or more associations between the first metadata and the second metadata;
determine the third metadata based on the one or more associations; and
validate the third metadata based on one or more other content items representing sensor information.

20. A method comprising:
determining a model based on one or more associations between metadata; and
determining a view of one or more content items in the context of an order, wherein the view is based on the model.

21. A method according to claim 20, further comprising:
determining one or more changes to the model based, at least in part, on usage of the content items.

22. A method according to claim 21, further comprising:
determining one or more rankings within the model; and
changing the one or more rankings within the model to optimize relevance between the model and the one or more content items.
